(19) United States
(12) Patent Application Publication
(10) Pub. No.: US 2025/0167612 A1
(43) Pub. Date: May 22, 2025

(54) AXIAL FLUX MOTOR AND GENERATOR

(71) Applicant: ShanmugaSundaram DEVASUNDARAM, Carmel, IN (US)

(72) Inventor: ShanmugaSundaram DEVASUNDARAM, Carmel, IN (US)

(21) Appl. No.: 18/948,442

(22) Filed: Nov. 14, 2024

Related U.S. Application Data
(60) Provisional application No. 63/599,611, filed on Nov. 16, 2023.

(51) Int. Cl. H02K 1/2796; H02K 3/28; H02K 7/02

(52) U.S. Cl. CPC H02K 1/2796; H02K 3/28; H02K 7/02

(57) ABSTRACT

An axial flux motor and generator, configured to function as both a motor and generator simultaneously, includes two stators and a rotor positioned in the gap between the stators. The rotor has a first surface that faces one of the stators and a second surface that faces the other one of the stators. A plurality of sets of magnets are fixedly attached to the rotor. A plurality of sets of windings are attached to the two stators. Each set of magnets is aligned with at least one of the sets of windings, and each set of magnets is arranged along a circumference that is concentric with the circumference of the other sets of magnets. In one example, each set of magnets is aligned with one of the sets of windings. In another example, each set of magnets is aligned with one set of windings on each of the two stators.

### CROSS-REFERENCE TO RELATED APPLICATIONS

This Application claims priority to U.S. Provisional Patent Application No. 63/599,611 filed on Nov. 16, 2023, entitled “Concentrically Built Axial Flux Motor & Axial Flux Generator with Shared Rotor,” the contents of which are incorporated herein by reference.

### BACKGROUND

### Field of the Art

The present invention is related to the field of electrical machinery, particularly to an axial flux motor and generator which operates simultaneously by employing a plurality of sets of magnets on a rotor and a plurality of sets of windings on stators.

### Discussion of the State of the Art

In the realm of electrical machinery, a persistent issue has been the efficiency of motor/generator systems. Conventional designs of these systems are typically configured to function as a motor when current is applied to one of the windings and to function as a generator when a prime mover is coupled to the shaft of the rotor. However, this configuration often poses challenges in terms of efficiency.

Previous attempts have been made to address these efficiency issues. Some of these attempts have involved modifications to the design and operation of the motor/generator system. However, these modifications have often resulted in suboptimal solutions. For instance, they have sometimes led to increased complexity in the system design, which in turn has led to challenges in manufacturing, maintenance, and operation. In addition, these modifications have often resulted in only marginal improvements in efficiency, and in some cases, they have even led to reductions in efficiency.

Moreover, the conventional design of the motor/generator system, where the system functions as a motor or a generator at different times, has limitations. This design often requires a significant amount of time and energy to switch between the motor mode and the generator mode. This switching process can be inefficient and can result in wasted energy. Furthermore, the need to switch modes can limit the usefulness of the system in applications where rapid switching between the motor mode and the generator mode is required.

In conclusion, while various attempts have been made to improve the efficiency of motor/generator systems, these attempts have often resulted in suboptimal solutions. The problem of efficient operation, therefore, remains a significant challenge in the field of electrical machinery.

### SUMMARY

The axial flux motor and generator in accordance with the present invention operates as both a motor and generator simultaneously. This dual-functionality is achieved through the integration of multiple sets of magnets on a rotor and correspondingly multiple sets of windings on stators. The unique alignment and layout allows for one set of windings to activate the rotation of the rotor, which in turn, prompts the other sets of windings to generate electricity.

The axial flux motor and generator addresses and overcomes the limitations of previous solutions by providing a device that can act as both a motor and generator concurrently. This not only eliminates the need for separate devices, but also optimizes the use of space and resources, enhancing efficiency and productivity.

Major benefits of this invention include reduction in equipment costs and space as it combines two applications into one device. The axial flux motor and generator also increases energy efficiency as the device is able to generate electricity while functioning as a motor. This can result in significant energy savings, making it an eco-friendly solution. Additionally, the device's simultaneous operation can lead to improvements in system responsiveness and overall performance. The axial flux motor and generator in accordance with the present invention, therefore, has significant potential for a wide range of applications in various industries including renewable energy, manufacturing, and transportation.

In one example, the present invention is an axial flux motor and generator that includes a rotor having a first set of magnets arranged along a first rotor circumference and a second set of magnets radially spaced from the first set of magnets and arranged along a second rotor circumference that is concentric with, and larger than, the first rotor circumference. Each one of the sets of magnets may include a plurality of magnets arranged in a pattern of alternating magnetic poles. The rotor may be a flywheel rotor.

The axial flux motor and generator also includes a stator having a first set of windings arranged along a first stator circumference and a second set of windings radially spaced from the first set of windings and arranged along a second stator circumference that is concentric with, and larger than, the first stator circumference. Each one of the windings may be a single layer concentrated winding, a multi-layer concentrated winding, a distributed winding, a pancake winding, a disc winding, a hairpin winding, a toroidal winding, a wave winding, a fractional-slot concentrated winding, a serpentine winding, a concentric winding, a parallel winding, a radial winding, an arc winding, or an unequal width parallel winding. In one example, the windings are concentrated windings or distributed windings.

The stator faces the rotor with a gap therebetween. The first rotor circumference is substantially equal to the first stator circumference such that the first set of magnets is aligned with the first set of windings. The second rotor circumference is substantially equal to the second stator circumference such that the second set of magnets is aligned with the second set of windings. The axial flux motor and generator may further include a third set of magnets arranged along a third rotor circumference and a third set of windings arranged along a third stator circumference. The third rotor circumference may be substantially equal to the third stator circumference such that the third set of magnets is aligned with the third set of windings.

The stator may be a first stator, and the axial flux motor and generator may further include a second stator. The rotor may be positioned between the first stator and the second stator with a first surface facing the first stator and a second surface facing the second stator.

In one example of the axial flux motor and generator that includes two stators, the first set of magnets and the second set of magnets may be positioned in openings that extend through the rotor such that a first side of each one of the magnets faces the first stator and a second side of each one of the magnets faces the second stator. The second stator may include a third set of windings arranged along a third stator circumference and a fourth set of windings radially spaced from the third set of windings and arranged along a fourth stator circumference that is concentric with, and larger than, the third stator circumference. The first rotor circumference may be substantially equal to the third stator circumference such that the second side of the first set of magnets is aligned with the third set of windings. The second rotor circumference may be substantially equal to the fourth stator circumference such that the second side of the second set of magnets is aligned with the fourth set of windings.

In another example of the axial flux motor and generator that includes two stators, the first set of magnets and the second set of magnets may be attached to the first surface of the rotor, and the rotor may further include a third set of magnets attached to the second surface of the rotor and a fourth set of magnets attached to the second surface of the rotor. The third set of magnets may be arranged along a third rotor circumference and the fourth set of magnets may be radially spaced from the third set of magnets and arranged along a fourth rotor circumference that is concentric with, and larger than, the third rotor circumference. The second stator may include a third set of windings arranged along a third stator circumference and a fourth set of windings radially spaced from the third set of windings and arranged along a fourth stator circumference that is concentric with, and larger than, the third stator circumference. The third rotor circumference may be substantially equal to the third stator circumference such that the third set of magnets is aligned with the third set of windings, and the fourth rotor circumference may be substantially equal to the fourth stator circumference such that the fourth set of magnets is aligned with the fourth set of windings.

In another example, the preset invention is an axial flux motor and generator that includes two stators separated by a gap, a rotor positioned in the gap between the two stators and having a first surface that faces one of the stators and a second surface that faces the other one of the stators, a plurality of sets of magnets fixedly attached to the rotor, and a plurality of sets of windings attached to the two stators. Each set of magnets is aligned with at least one of the sets of windings. Each set of magnets is arranged along a circumference that is concentric with the other sets of magnets.

In one example of the rotor, the plurality of sets of magnets may include a first set of magnets attached to the first surface of the rotor, a second set of magnets attached to the first surface of the rotor, a third set of magnets attached to the second surface of the rotor, and a fourth set of magnets attached to the second surface of the rotor. The first set of magnets may be arranged along a first circumference that is concentric with a rotation axis of the rotor, and the second set of magnets may be arranged along a second circumference that is concentric with, and larger than, the first circumference. The third set of magnets may be arranged along a third circumference that is concentric with the rotation axis of the rotor, and the fourth set of magnets may be arranged along a fourth circumference that is concentric with, and larger than, the third circumference.

In another example of the rotor, the rotor may include a plurality of openings, and each one of the magnets may be positioned in one of the openings such that a first side of each one of the magnets faces one of the stators and a second side of each one of the magnets faces the other one of the stators. The plurality of sets of magnets may include a first set of magnets arranged along a first circumference that is concentric with a rotation axis of the rotor, and a second set of magnets arranged along a second circumference that is concentric with, and larger than, the first circumference.

The two stators may include a first stator and a second stator. The plurality of sets of windings may include a first set of windings attached to the first stator, a second set of winding attached to the first stator, a third set of windings attached to the second stator, and a fourth set of windings attached to the second stator. The first side of the first set of magnets may be aligned with the first set of windings, the first side of the second set of magnets may be aligned with the second set of windings, the second side of the first set of magnets may be aligned with the third set of windings, and the second side of the second set of magnets may be aligned with the fourth set of windings.

In yet another example, the present invention is a method of using an axial flux motor and generator. The axial flux motor and generator includes a first set of magnets aligned with a first set of windings around a first circumference, and a second set of magnets aligned with a second set of windings around a second circumference that is larger than, and concentric with, the first circumference. The method includes applying current to the first set of windings to cause a rotor to rotate, and collecting electrical output generated by the second set of windings.

In still another example, the present invention is a method of using an axial flux motor and generator. The axial flux motor and generator includes a first set of magnets aligned with a first set of windings around a first circumference, a second set of magnets aligned with a second set of windings around a second circumference that is larger than, and concentric with, the first circumference, and a third set of magnets aligned with a third set of windings around a third circumference that is larger than, and concentric with the second circumference. The method includes applying current to all of the windings to cause a rotor to rotate, determining that the rotor has reached a predetermined angular velocity, turning off the current to the second set of windings and the third set of windings while continuing to apply current to the first set of windings, and collecting electrical output generated by the second set of windings and the third set of windings.

### BRIEF DESCRIPTION OF THE DRAWINGS

The accompanying drawings illustrate several embodiments and, together with the description, serve to explain the principles of the invention according to the embodiments. It will be appreciated by one skilled in the art that the particular arrangements illustrated in the drawings are merely exemplary and are not to be considered as limiting of the scope of the invention or the claims herein in any way.

FIGS. 1A and 1B are perspective views of an axial flux motor and generator, in accordance with an embodiment of the present invention.

FIG. 1C is a top plan view of an axial flux motor and generator, in accordance with an embodiment of the present invention.

FIGS. 2A and 2B are perspective and front views, respectively, of a rotor for an axial flux motor and generator, in accordance with an embodiment of the present invention.

FIGS. 3A and 3B are front views of a rotor for an axial flux motor and generator, in accordance with an embodiment of the present invention.

FIG. 4 is a front view of a stator for an axial flux motor and generator, in accordance with an embodiment of the present invention.

FIGS. 5 and 6 are flowcharts of methods for using an axial flux motor and generator, in accordance with an embodiment of the present invention.

### DETAILED DESCRIPTION

The present invention is an axial flux motor and generator that is configured to function as both a motor and generator at the same time. The axial flux motor and generator includes a rotor having a plurality of concentric sets of magnets attached thereto. The axial flux motor and generator further includes stators having a plurality of windings attached thereto, where each one of the sets of windings is aligned with one of the sets of magnets on the rotor.

The invention is described by reference to various elements herein. It should be noted, however, that although the various elements of the inventive apparatus are described separately below, the elements need not necessarily be separate. The various embodiments may be interconnected and may be cut out of a singular block or mold. The variety of different ways of forming an inventive apparatus, in accordance with the disclosure herein, may be varied without departing from the scope of the invention.

One or more different embodiments may be described in the present application. Further, for one or more of the embodiments described herein, numerous alternative arrangements may be described; it should be appreciated that these are presented for illustrative purposes only and are not limiting of the embodiments contained herein or the claims presented herein in any way. One or more of the arrangements may be widely applicable to numerous embodiments, as may be readily apparent from the disclosure. In general, arrangements are described in sufficient detail to enable those skilled in the art to practice one or more of the embodiments, and it should be appreciated that other arrangements may be utilized and that structural, logical, software, electrical and other changes may be made without departing from the scope of the embodiments. Particular features of one or more of the embodiments described herein may be described with reference to one or more particular embodiments or figures that form a part of the present disclosure, and in which are shown, by way of illustration, specific arrangements of one or more of the aspects. It should be appreciated, however, that such features are not limited to usage in the one or more particular embodiments or figures with reference to which they are described. The present disclosure is neither a literal description of all arrangements of one or more of the embodiments nor a listing of features of one or more of the embodiments that must be present in all arrangements.

Headings of sections provided in this patent application and the title of this patent application are for convenience only and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible embodiments and in order to more fully illustrate one or more embodiments. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the embodiments, and does not imply that the illustrated process is preferred. Also, steps are generally described once per aspect, but this does not mean they must occur once, or that they may only occur once each time a process, method, or algorithm is carried out or executed. Some steps may be omitted in some embodiments or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various embodiments in which, for example, functions may be executed out of order from that shown or discussed, including substantially concurrently or in reverse order, depending on the functionality involved, as would be understood by those having ordinary skill in the art.

The detailed description set forth herein in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

### Apparatus

The axial flux motor and generator of the present invention is designed to function as both a motor and generator at the same time. The magnets on the rotor are arranged in sets of concentric circles and the windings on the stator are similarly arranged in sets of concentric circles so that each set of windings is associated with one of the sets of magnets. When a current is applied to one of the sets of windings, causing an interaction between that set of windings and its associated set of magnets, the rotor rotates relative to the stator. The interaction between the other sets of magnets and their associated sets of windings cause the windings to generate electrical output.

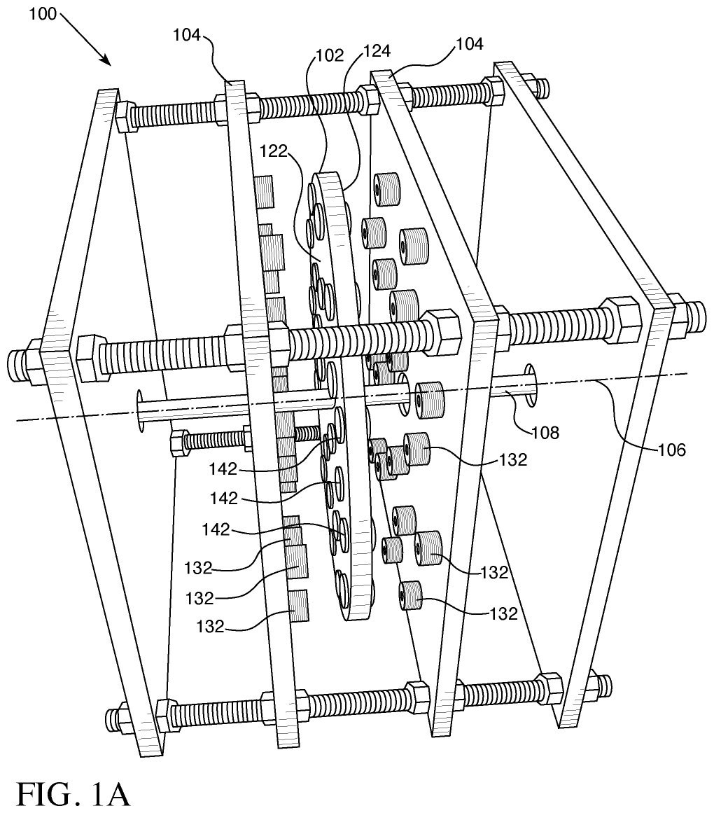

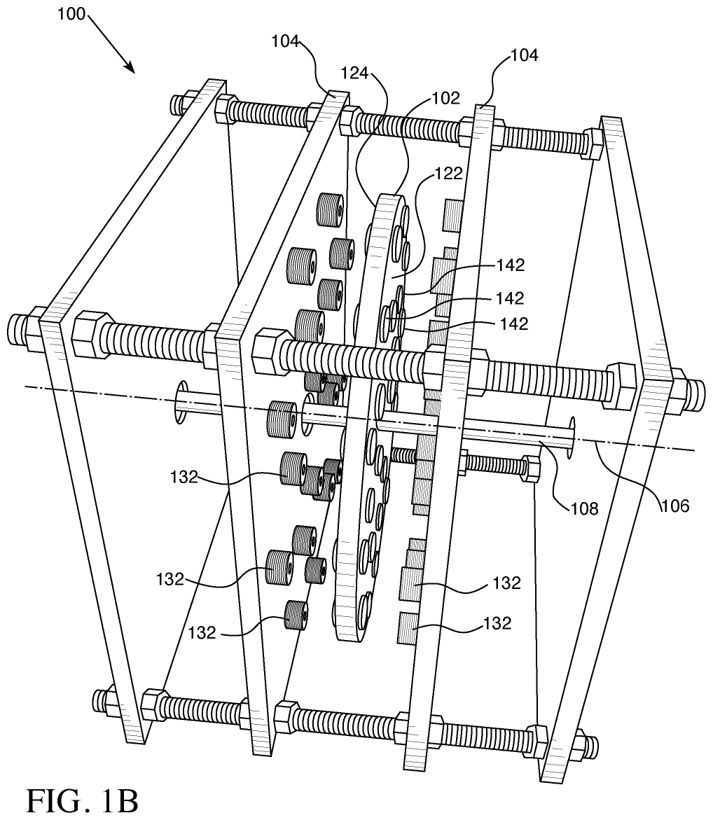

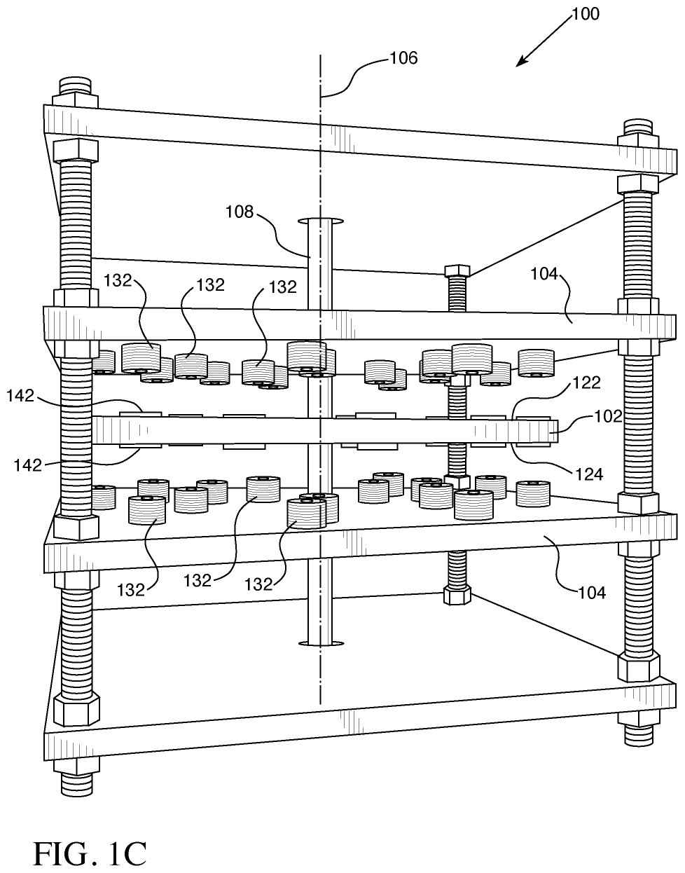

As illustrated in FIGS. 1A-1C, the axial flux motor and generator 100 of the present invention includes a rotor 102 and two stators 104, a shaft 108 passes through the center of the stators 104 and the rotor 102 and is thus positioned along the axis of rotation 106. The rotor 102 is centrally positioned between the two stators 104, with a first surface 122 of the rotor 102 facing one stator 104 and a second surface 124 of the rotor 102 facing the other stator 104. As such, both surfaces 122, 124 of the rotor 102 are perpendicular to the axis of rotation 106. The rotor 102 can take various forms, including, but not limited to, a flywheel rotor. The rotor 102 is configured to rotate, while the stators 104 remain stationary during the operation of the device 100.

The two stators 104 are separated from each other by a gap, within which the rotor 102 is positioned. The rotor 102 and the stators 104 are separated from each other by a small gap on either side of the rotor 102, allowing for efficient rotation of the rotor 102 without physical contact with the stators 104. Each stator 104 includes multiple sets of windings 132 attached thereto, and the rotor 102 includes multiple sets of magnets 142 attached thereto.

The axis of rotation 106 passes through the center of the rotor 102 and the stators 104, providing a central pivot around which the rotor 102 rotates. The rotor 102 is fixedly coupled to the shaft 108 so that the rotor 102 and the shaft 108 rotate together. The shaft 108 and rotor 102 rotate relative to the stators 104.

In the example shown in FIGS. 1A-1C, the rotor 102 is positioned between two stators 104, but the configuration can vary depending on the specific application and performance requirements of the device. For instance, in some embodiments of the axial flux motor and generator, there may be two rotors and one stator. In this alternative configuration, one rotor is positioned on each side of the stator. Another embodiment includes a single stator, so the rotor includes magnets only on the rotor surface that faces the stator. In these single-stator configurations, the stator and rotor are configured to interact in a similar manner as described herein. However, the use of a single stator may be less efficient compared to the use of two stators, as the single-stator configuration might limit the amount of electrical output that can be generated.

The axial flux motor and generator 100 can be used in systems requiring the simultaneous operations of motor and generator functions while maintaining a compact design. The rotor 102 and stator 104 configuration is versatile and capable of being incorporated into a myriad of applications, from small-scale electronics to large-scale industrial machinery.

The specific configuration of the rotor, stators, magnets, and windings, as well as their spatial relationships, can be varied based on the specific application and performance requirements. This provides a flexible and efficient design for an axial flux motor and generator capable of simultaneous operation.

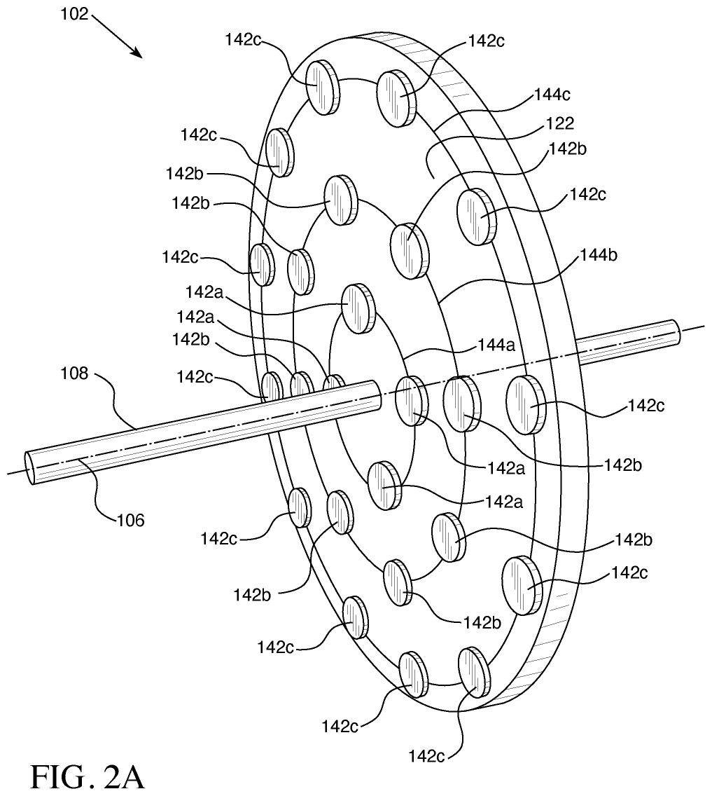

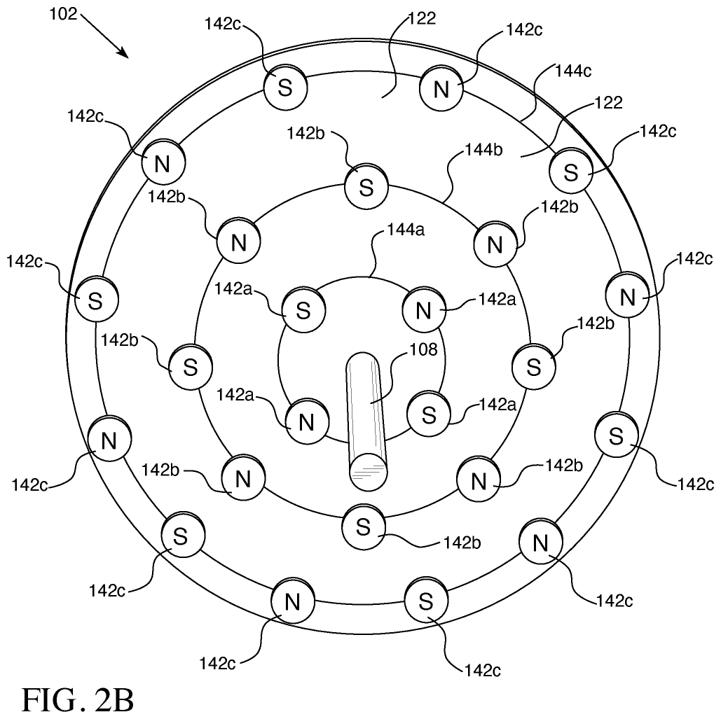

The rotor 102 has a plurality of sets of magnets 142 coupled thereto. Each one of the sets of magnets 142 is concentric with the other sets of magnets 142. In one example, shown in FIGS. 2A and 2B, the rotor 102 includes three sets of magnets 142a, 142b, 142c (collectively referred to as “magnets 142”) attached to one side 122 of the rotor 102 and three sets of magnets 142 attached to the opposite side (not shown in FIGS. 2A and 2B) of the rotor 102, for a total of six sets of magnets 142.

It should be noted that the axial flux motor and generator 100 is not limited to having three sets of magnets on each side of the rotor 102. Rather, the rotor 102 may have 2, 4, 5, 6, or more sets of magnets on each side 122, 124. While the axial flux motor and generator 100 may have two or more sets of magnets on the rotor, there is no upper limit to the number of sets of magnets that may be used. Each set of magnets is arranged around a circumference that is concentric with the circumferences of the other sets of magnets. The number of sets of magnets can be modified based on specific design requirements and performance objectives. For instance, increasing the number of sets of magnets can potentially amplify the magnetic field, leading to a higher electrical output. Conversely, reducing the number of sets can simplify the design and potentially lower the manufacturing costs.

Although the magnets 142 are depicted as having a round cross-sectional shape, the axial flux motor and generator 100 is not limited to having circular magnets. Rather, the magnets may have a cross-sectional shape that is square, rectangular, triangular, oval, or any other desired cross-sectional shape.

The plurality of sets of magnets 142 attached to the first surface 122 of the rotor 102 are arranged in concentric circles. That is, the magnets 142 in each one of the sets of magnets is arranged around a circumference that is concentric with the axis of rotation 106 and with the circumferences of the other sets of magnets. In the example shown in FIGS. 2A and 2B, the rotor 102 includes a first set of magnets 142a arranged along a first circumference 144a, a second set of magnets 142b arranged along a second circumference 144b, and a third set of magnets 142c arranged along a third circumference 144c. All of the circumferences 144a, 144b, 144c are concentric with the axis of rotation 106. The magnets 142 in each set are arranged in a pattern of alternating polarity, as shown in FIG. 2B.

The second surface 124 of the rotor 102 also includes a plurality of magnets 142 arranged in concentric sets, substantially similar to the arrangement shown in FIGS. 2A and 2B. As such, sets of magnets 142 on the first side 122 of the rotor 102 face one of the stators 104 and the sets of magnets 142 on the second side 124 of the rotor 102 face the other one of the stators 104. In this example, the number of sets of magnets is equal to the number of sets of windings.

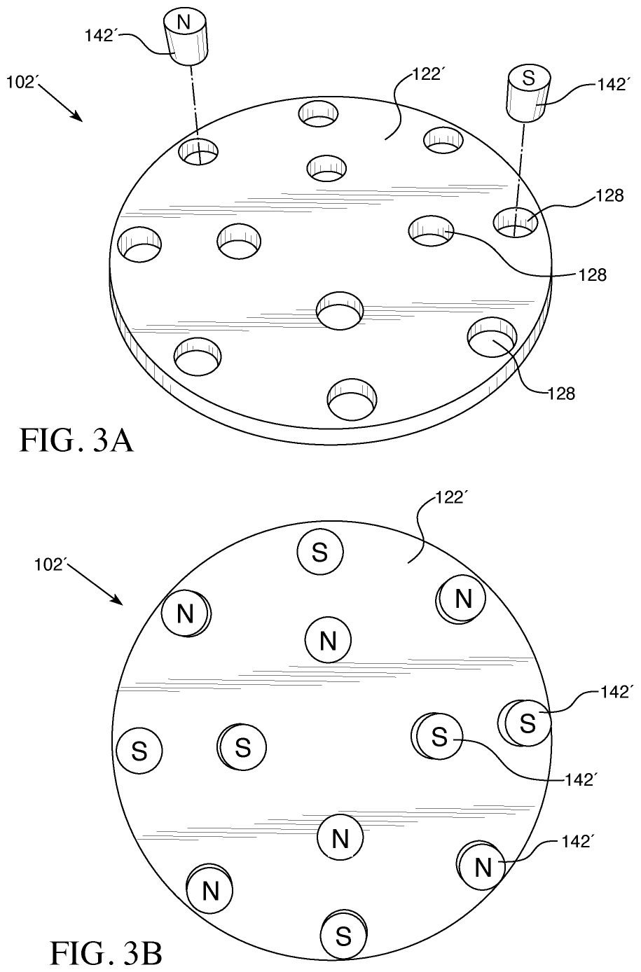

In another example, shown in FIGS. 3A and 3B, the rotor 102′ includes a plurality of openings 128 that extend therethrough between the first surface 122′ and the second surface (not shown) and the plurality of magnets 142′ are positioned in the openings 128. This manner of attaching the magnets 142′ to the rotor 102′ is advantageous over the previous example shown in FIGS. 2A and 2B because the magnets 142′ are more likely to stay in their desired positions within the openings 128. With the magnets 142 attached to the surfaces 122, 124 of the rotor 102, as shown in FIGS. 2A and 2B, there is a risk of the magnets 142 becoming dislodged from their desired positions.

In the example shown in FIGS. 3A and 3B, one side of each magnet 142′ is positioned on the first surface 122′ of the rotor 102′, while the opposite side of each magnet 142′ is positioned on the second surface of the rotor 102′. While the ends of the magnets 142′ may protrude out of the openings 128 on either side of the rotor 102′, the entire middle portion of each magnet 142′ is completely housed within the opening 128, thereby securing the magnets 142′ in place in the rotor 102′. With this arrangement, a first side of each magnet 142′ interacts with the windings 132 on one of the stators 104, while a second side of each magnet 142′ interacts with the windings 132 on the other one of the stators 104. In this example, the number of sets of windings 132 is double of the number of sets of magnets 142 since each set of magnets 142 interacts with two sets of windings 132. As shown in FIG. 3B, the magnets 142′ are arranged in concentric circles and have a pattern of alternating polarity.

Although the magnets 142′ are depicted as being cylindrical, the axial flux motor and generator 100 is not limited to having cylindrical magnets. Rather, the magnets may have a cross-sectional shape that is square, rectangular, triangular, oval, or any other desired cross-sectional shape.

Corresponding to the set of magnets 142 on the rotor 102, each stator 104 is equipped with multiple sets of windings 132 attached to it. When current is applied to one of these sets of windings 132, it creates a magnetic field that interacts with the magnetic fields of a corresponding set of magnets 142 on the rotor 102. This interaction induces the rotor 102 to spin around the axis of rotation 106. As the rotor 102 spins, the other sets of windings 132 on the stators 104, which are in proximity to the rotating magnets 142, generate an electrical output.

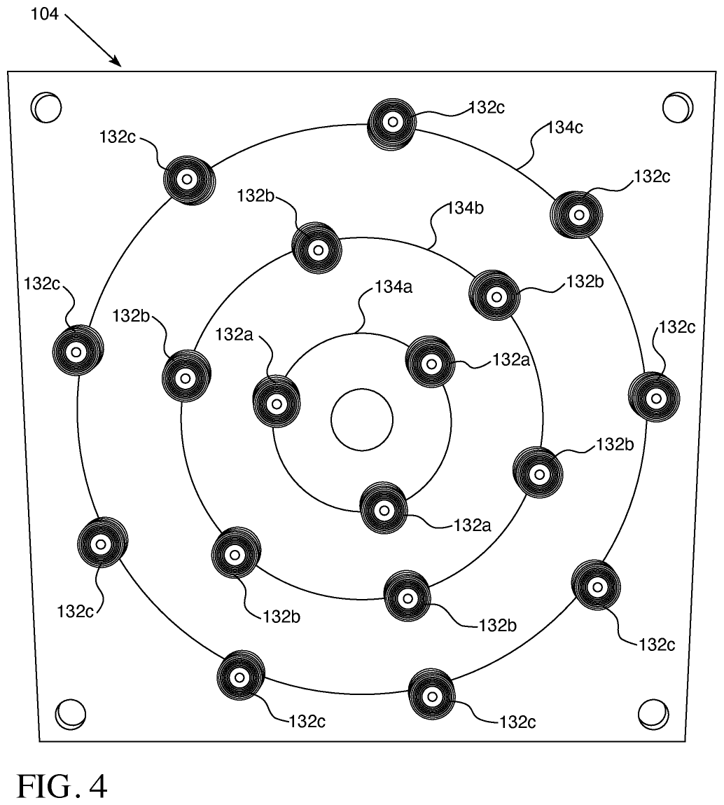

The plurality of windings 132 on the stator 104 are arranged in a pattern similar to that of the plurality of magnets 142 on the rotor 102, as shown in FIG. 4. In particular, the windings 132 are arranged in sets of concentric circles. In the example shown in FIG. 4, the stator 104 includes a first set of windings 132a positioned around a first circumference 134a, a second set of windings 132b positioned around a second circumference 134b, and a third set of windings 132c positioned around a third circumference 134c. The circumferences 134 are all concentric with the axis of rotation 106. Further, the circumferences 134 are substantially equal to the circumferences 144 of the sets of magnets. That is, the first stator circumference 134a is approximately equal to the first rotor circumference 144a, the second stator circumference 134b is approximately equal to the second rotor circumference 144b, and the third stator circumference 134c is approximately equal to the third rotor circumference 144c. It should be noted that the axial flux motor and generator 100 is not limited to having three sets of windings 132 on each stator 104. Rather, each one of the stators 104 may have 2, 4, 5, 6, or more sets of windings attached thereto.

While the particular type of winding used can vary based on the specific application and performance requirements, various types of windings known in the art can be utilized. For example, the windings may be single layer concentrated windings, multi-layer concentrated windings, distributed windings, pancake windings, disc windings, hairpin windings, toroidal windings, wave windings, fractional-slot concentrated windings, serpentine windings, concentric windings, parallel windings, radial windings, arc windings, unequal width parallel windings, and/or the like. Each of these types of windings has its own characteristics and can provide different performance attributes. The choice of winding type can be made based on factors such as the desired efficiency, power output, size constraints, cost considerations, and other design or performance requirements. Further, each set of windings may be a different type of winding. For example, the first set of windings 132a may be concentrated windings, while the second set of windings 132b may be distributed windings, and the third set of windings 132c may be disc windings, or other such combinations. Notably, the type of windings on the stators need to match each other (e.g., the first set of windings 132a on each one of the stators need to be the same type as each other, the second set of windings 132b on each one of the stators need to be the same type as each other even if they are a different type from the first set 132a, etc.).

The windings 132 may be arranged or designed to produce single phase or multiphase alternating current output from every set of windings. Multiphase output would advantageously increase the overall electrical power output of the axial flux motor and generator.

Despite these potential variations in design and configuration, the primary function of the stators, which is to interact with the rotor to generate an electrical output, remains constant. The specific configuration chosen would depend on the specific requirements of the application, including considerations related to space, cost, power requirements, and efficiency.

In operation, when a current is applied to one of the sets of windings 132, a magnetic field is generated that interacts with the corresponding set of magnets 142, which causes the rotor 102 to rotate. Simultaneously, the rotation of the rotor 102 and its attached magnets induces a changing magnetic field in the other sets of windings 132, thereby causing them to generate an electrical output. This dual functionality allows the device 100 to operate as both a motor and a generator.

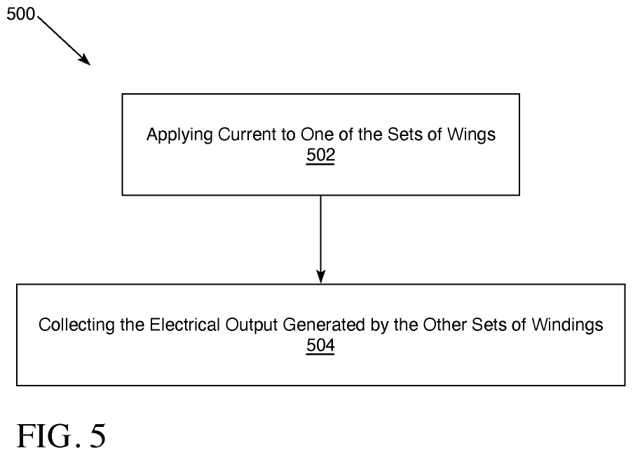

There are many different ways to operate the axial flux motor and generator, depending on the needs of the user or the specific situation. In one example, shown in FIG. 5, a method 500 of using the axial flux motor and generator includes applying current to one of the sets of windings (step 502) and collecting the electrical output generated by the other sets of windings (step 504).

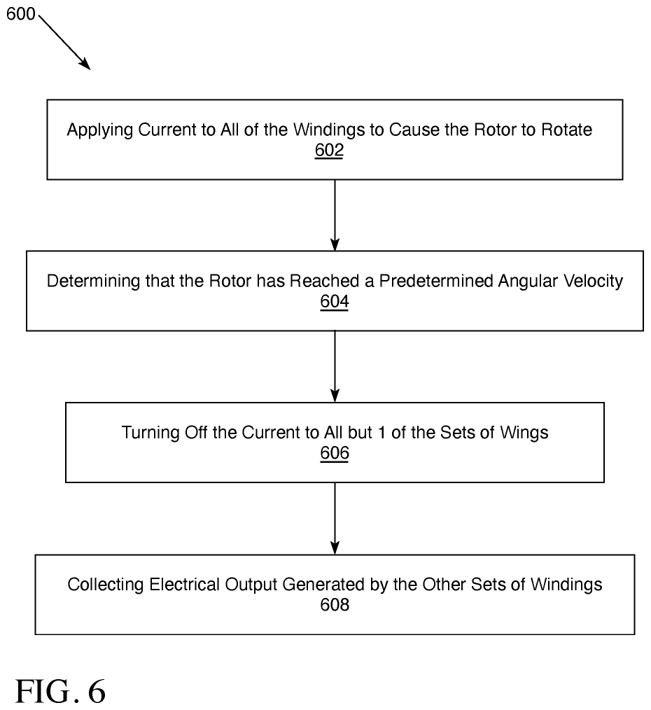

As shown in FIG. 6, another method 600 of using the axial flux motor and generator 100 includes a first step 602 of applying current to all of the windings to cause a rotor to rotate. Next, step 604 includes determining that the rotor has reached a predetermined angular velocity. Next, step 606 includes turning off the current to all but one of the sets of windings so that current is being applied to only one of the sets of windings. Finally, step 608 includes collecting electrical output generated by the other sets of windings on the stator. That is, while current is applied to one of the sets of windings, the remaining sets of windings are generating electrical output.

### Additional Considerations

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and/or a process associated with the disclosed principles herein. Thus, while particular embodiments and applications have been illustrated and described, it is to be understood that the disclosed embodiments are not limited to the precise construction and components disclosed herein. Various apparent modifications, changes and variations may be made in the arrangement, operation and details of the method and apparatus disclosed herein without departing from the spirit and scope defined in the appended claims.

What is claimed is:

1. An axial flux motor and generator comprising:
a rotor having a first set of magnets arranged along a first rotor circumference and a second set of magnets radially spaced from the first set of magnets and arranged along a second rotor circumference that is concentric with, and larger than, the first rotor circumference; and
a stator having a first set of windings arranged along a first stator circumference and a second set of windings radially spaced from the first set of windings and arranged along a second stator circumference that is concentric with, and larger than, the first stator circumference,
wherein the stator faces the rotor with a gap therebetween,
wherein the first rotor circumference is substantially equal to the first stator circumference such that the first set of magnets is aligned with the first set of windings, and
wherein the second rotor circumference is substantially equal to the second stator circumference such that the second set of magnets is aligned with the second set of windings.

2. The axial flux motor and generator of claim 1, further comprising a third set of magnets arranged along a third rotor circumference and a third set of windings arranged along a third stator circumference, wherein the third rotor circumference is substantially equal to the third stator circumference such that the third set of magnets is aligned with the third set of windings.

3. The axial flux motor and generator of claim 1, wherein each one of the sets of magnets comprises a plurality of magnets arranged in a pattern of alternating magnetic poles.

4. The axial flux motor and generator of claim 1, wherein each one of the windings is one of: a single layer concentrated winding, a multi-layer concentrated winding, a distributed winding, a pancake winding, a disc winding, a hairpin winding, a toroidal winding, a wave winding, a fractional-slot concentrated winding, a serpentine winding, a concentric winding, a parallel winding, a radial winding, an arc winding, and an unequal width parallel winding.

5. The axial flux motor and generator of claim 1, wherein each one of the windings is a concentrated winding or a distributed winding.

6. The axial flux motor and generator of claim 1, wherein the rotor is a flywheel rotor.

7. The axial flux motor and generator of claim 1, wherein the stator is a first stator, wherein the axial flux motor and generator further comprises a second stator, and wherein the rotor is positioned between the first stator and the second stator, wherein the rotor comprises a first surface facing the first stator and a second surface facing the second stator.

8. The axial flux motor and generator of claim 7, wherein the first set of magnets and the second set of magnets are positioned in openings that extend through the rotor such that a first side of each one of the magnets faces the first stator and a second side of each one of the magnets faces the second stator.

9. The axial flux motor and generator of claim 8, wherein the second stator comprises a third set of windings arranged along a third stator circumference and a fourth set of windings radially spaced from the third set of windings and arranged along a fourth stator circumference that is concentric with, and larger than, the third stator circumference.

10. The axial flux motor and generator of claim 9, wherein the first rotor circumference is substantially equal to the third stator circumference such that the second side of the first set of magnets is aligned with the third set of windings, and
wherein the second rotor circumference is substantially equal to the fourth stator circumference such that the second side of the second set of magnets is aligned with the fourth set of windings.

11. The axial flux motor and generator of claim 7, wherein the first set of magnets and the second set of magnets are attached to the first surface of the rotor, and wherein the rotor further comprises a third set of magnets attached to the second surface of the rotor and a fourth set of magnets attached to the second surface of the rotor.

12. The axial flux motor and generator of claim 11, wherein the third set of magnets is arranged along a third rotor circumference and the fourth set of magnets is radially spaced from the third set of magnets and arranged along a fourth rotor circumference that is concentric with, and larger than, the third rotor circumference.

13. The axial flux motor and generator of claim 12, wherein the second stator comprises a third set of windings arranged along a third stator circumference and a fourth set of windings radially spaced from the third set of windings and arranged along a fourth stator circumference that is concentric with, and larger than, the third stator circumference.

14. The axial flux motor and generator of claim 13, wherein the third rotor circumference is substantially equal to the third stator circumference such that the third set of magnets is aligned with the third set of windings, and
wherein the fourth rotor circumference is substantially equal to the fourth stator circumference such that the fourth set of magnets is aligned with the fourth set of windings.

15. An axial flux motor and generator, comprising:
two stators separated by a gap;
a rotor positioned in the gap between the two stators and having a first surface that faces one of the stators and a second surface that faces the other one of the stators;
a plurality of sets of magnets fixedly attached to the rotor; and
a plurality of sets of windings attached to the two stators, wherein each set of magnets is aligned with at least one of the sets of windings,
wherein each set of magnets is arranged along a circumference that is concentric with the other sets of magnets.

16. The axial flux motor and generator of claim 15, wherein the plurality of sets of magnets comprises a first set of magnets attached to the first surface of the rotor, a second set of magnets attached to the first surface of the rotor, a third set of magnets attached to the second surface of the rotor, and a fourth set of magnets attached to the second surface of the rotor.

17. The axial flux motor and generator of claim 16, wherein the first set of magnets is arranged along a first circumference that is concentric with a rotation axis of the rotor, and the second set of magnets is arranged along a second circumference that is concentric with, and larger than, the first circumference, and
wherein the third set of magnets is arranged along a third circumference that is concentric with the rotation axis of the rotor, and the fourth set of magnets is arranged along a fourth circumference that is concentric with, and larger than, the third circumference.

18. The axial flux motor and generator of claim 15, wherein the rotor comprises a plurality of openings, and wherein each one of the magnets is positioned in one of the openings such that a first side of each one of the magnets faces one of the stators and a second side of each one of the magnets faces the other one of the stators.

19. The axial flux motor and generator of claim 18, wherein the plurality of sets of magnets comprises a first set of magnets arranged along a first circumference that is concentric with a rotation axis of the rotor, and a second set of magnets arranged along a second circumference that is concentric with, and larger than, the first circumference.

20. The axial flux motor and generator of claim 19, wherein the two stators comprise a first stator and a second stator,
wherein the plurality of sets of windings comprises a first set of windings attached to the first stator, a second set of winding attached to the first stator, a third set of windings attached to the second stator, and a fourth set of windings attached to the second stator, and
wherein the first side of the first set of magnets is aligned with the first set of windings, the first side of the second set of magnets is aligned with the second set of windings, the second side of the first set of magnets is aligned with the third set of windings, and the second side of the second set of magnets is aligned with the fourth set of windings.
